(19) United States
(12) Patent Application Publication
(10) Pub. No.: US 2021/0237699 A1
(43) Pub. Date: Aug. 5, 2021

(54) ALTERNATING BRAKING METHOD FOR SMOOTH STOPPING FROM ADAPTIVE CRUISE CONTROL

(71) Applicant: Ford Global Technologies, LLC, Dearborn, MI (US)

(72) Inventors: Arne Boden, Mönchengladbach (DE); Karl-Peter Hesseler, Siegburg (DE); Thomas Svensson, Leichlingen (DE)

(21) Appl. No.: 16/783,159

(22) Filed: Feb. 5, 2020

(51) Int. Cl. B60T 8/17; B60T 7/12; B60T 8/26; B60T 8/171

(52) U.S. Cl. CPC B60T 8/17; B60T 7/12; B60T 2201/022; B60T 8/171; B60T 8/26

(57) ABSTRACT

The present disclosure relates to a system and a method for alternating braking for smooth stopping. The system includes a vehicle having a plurality of proximity sensors coupled to an adaptive cruise control system. A braking system is coupled to the adaptive cruise control system that controls a front and a rear wheel braking system in different patterns. When one of the proximity signals is a distance below the threshold distance, the adaptive cruise control system activates the braking system. The front and the rear wheel braking systems may be activated for a first and a second time period, respectively. The first and the second time periods correspond to a first and a second braking pattern, respectively.

### BACKGROUND

### Technical Field

The present disclosure is directed to a system and method of alternating braking between front and rear braking systems of a moving vehicle to achieve a smooth stop while utilizing an adaptive cruise control.

### Description of the Related Art

Adaptive cruise control (ACC) or dynamic cruise control systems are becoming more common in vehicles and can provide collision warning and avoidance. The ACC system automatically adjusts the speed of the vehicle to maintain a safe distance from other vehicles or objects in the vehicle's predicted path of travel.

When driving under normal conditions, a driver of the vehicle sets the ACC system with a speed that corresponds to a maximum autonomous speed desired, often highway speeds. The ACC system utilizes the set speed to control the speed of the vehicle in a conventional cruise control mode. When the vehicle begins approaching other vehicles or objects in the predicted path of travel, such that relative speed of the other vehicles or the objects is lower than the set speed, the ACC system dynamically adjusts the speed of the vehicle. This enables the vehicle to maintain a minimum distance (a safe distance) with the other vehicles or the objects that are in the predicted path of travel. When the distance from the other vehicles or the objects increases above the minimum distance, the ACC system increases the speed of the vehicle to reach the set speed. Alternatively, when the other vehicles or the objects in the predicted path of travel accelerate above the set speed of the vehicle, the ACC system resumes the conventional cruise control mode to increase the speed of the vehicle to the set speed.

### BRIEF SUMMARY

The present disclosure relates to a system and method of controlling braking in a vehicle while an adaptive cruise control (ACC) system (or an autonomous braking or driving system) is activated so that a driver and passengers experience a smooth, controlled stop as opposed to a harsh, shaky, or otherwise unpleasant stop when the ACC system reduces the speed of the vehicle. The harsh or shaky movements of the vehicle are related to the heat generated by the brakes when engaged quickly. In order to accommodate heat generated by braking quickly, such as from highways speeds to less than 5 kilometers per hour in less than 200 milliseconds, the ACC system will activate a front wheel braking system at a different pattern than the rear or back wheel braking system. Operating the front and rear wheel braking system at a different pattern will allow the non-activated braking system to be cooling during the time period the other braking system is activated.

The vehicle includes a braking system that is integrated with the adaptive cruise control system, a plurality of proximity sensors, and a processor. The processor may be a dedicated electronic control unit that communicates through a controller area network or may be another processing module integrated within a larger central processing unit of the vehicle. The braking system includes the front wheel braking system and the rear wheel braking system that are each coupled to the respective front and rear wheels. In operation, the processor receives distance information, from one or more of the plurality of proximity sensors, which are coupled to a front end of the vehicle. The distance information is a measure or a plurality of measurements of distance between the vehicle and other vehicles or objects in a predicted path of travel, i.e. in a forward direction. The processor analyzes the distance information and based on predetermined thresholds for safe distances between vehicles, activates the braking system if a threshold safe distances is exceeded. Said differently, if the vehicle receives distance information from the sensors indicating that another vehicle is too close, the ACC system will send control signals to start activating the braking system.

While braking from greater than 20 kilometers per hour to zero, or stand still, a brake friction value has a wide dispersion. At a residual velocity between 0 and 5 kilometers per hour, the brake friction value can vary up to 50%. Such variation is a challenged for ACC deceleration and acceleration control, which evaluates and uses a pressure to torque value (Cp) to achieve a controlled stop.

To achieve a smooth stop and minimize the variation in brake friction values, the vehicle will activate the front wheel braking system for a first time period and the rear wheel braking system for a second time period once a deceleration sequence has been initiated. The first time period may be activated first in this pattern, with the first time period being greater than the second time period in one embodiment. In an alternate embodiment, the first time period is three times greater than the second time period such that the front braking system is engaged longer than the rear braking system, maximizing a cooling period of the rear braking system.

Activating the front braking system in a different engagement pattern than the rear braking system will allow for mitigation or avoidance of a wide dispersion of pressure to torque values at low speeds where there is great benefit to keeping a temperature of the front and rear braking systems low.

According to another embodiment of the present disclosure, when the distance measured by the one or more plurality of proximity sensors falls below the predetermined threshold, the processor generates a deceleration signal, as a result of which the processor activates the front wheel braking system for the first time period and the rear wheel braking system for the second time period. The first time period and the second time period have portions of an increasing brake pressure, a stable brake pressure and a decreasing brake pressure. The portion of the decreasing brake pressure of the first time period for the front wheel braking system overlaps with the portion of the increasing brake pressure of the second time period for the rear wheel braking system.

In yet another embodiment of the present disclosure, when the distance measured by the one or more of the plurality of proximity sensors falls below the predetermined threshold, the processor generates an adaptive cruise control braking signal. As a response to the adaptive cruise control braking signal, the processor activates the front wheel braking system in a first braking pattern and the rear wheel braking system in a second braking pattern. The first braking pattern is different from the second braking pattern. The first braking pattern may be initiated before the second braking pattern. The first braking pattern and the second braking pattern include plurality of periods of increasing brake pressure, maintained brake pressure, and decreasing brake pressure that repeat and overlap. Heat is generated most during the increasing brake pressure portion.

The plurality of the decreasing portions of the second braking pattern may overlap with the plurality of the increasing portion of the first braking pattern to maintain a smooth stop experience for the driver or passengers. By alternating which braking system, rear or front is experiencing the increasing brake pressure portion, the heat build-up and subsequent physical, vibrational consequences are minimized or avoided.

### BRIEF DESCRIPTION OF THE SEVERAL VIEWS OF THE DRAWINGS

The system may be better understood with reference to the following figures and description. The components in the figures are not necessarily to scale, emphasis instead being placed upon illustrating the principles of the disclosure. In the figures, identical reference numbers identify similar elements or acts. Some elements may be enlarged and positioned to improve drawing legibility.

FIG. 1 is a block diagram of a system that controls braking of a vehicle according to an embodiment of the present disclosure.

FIG. 2 is a graph of a braking process that may lead to harsh braking.

FIG. 3 is a graph of pressure to torque (Cp) value variation with respect to variation in speed for vehicles, such as Electric Brake Booster (EBB) vehicles.

FIG. 4 is a graph of a smooth braking pattern of brake control according to an embodiment of the present disclosure.

FIG. 5 is a graph of a smooth braking pattern of brake control according to another embodiment of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or methods associated with vehicles and braking systems have not been shown or described in detail to avoid unnecessarily obscuring descriptions of the embodiments.

Unless the context indicates otherwise, throughout the specification and claims which follow, the word “comprise” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

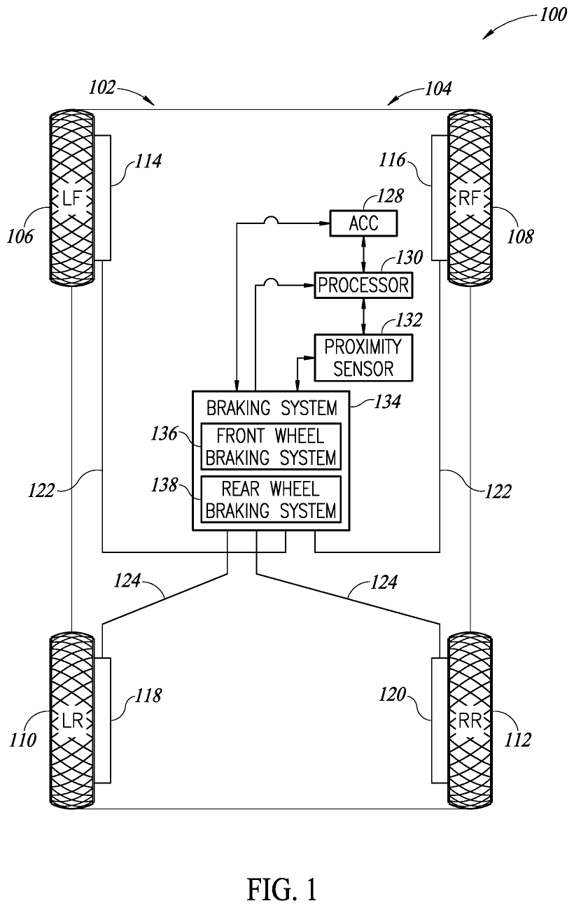

The present disclosure is directed a system 100 in FIG. 1 for controlling braking operation of a vehicle 102, while an adaptive cruise control (ACC) system 128 is activated so that a driver and passengers of the vehicle 102 experience a smooth, controlled stop, according to an embodiment of the present disclosure. The vehicle 102, for example, is an Electric Brake Booster (EBB) vehicle that requires low pedal pressure for the braking operation. A similar system and method can be implemented in other electronically activated braking systems or autonomous vehicles. In such autonomous vehicles, the ACC system may be omitted and the features as described herein with respect to the ACC may be integrated into an autonomous driving or braking system that controls speed in light of the environment, through sensors. The autonomous systems collect data from the sensors, from global positioning systems and other location based systems, from vehicle to vehicle data sharing, among others. The autonomous systems can implement the front and rear wheel alternating braking patterns in response to the various inputs they receive, achieving a smooth stop.

The vehicle 102 includes a front wheel braking system 136 is coupled to a left front wheel 106 and a right front wheel 108. The front wheel braking system may include a first brake fluid circuit 122 coupled to a left front wheel brake actuator 114 and a right front wheel brake actuator 116, respectively coupled to the left and right front wheels 106, 108. The rear wheel braking system 138 is coupled to a left rear wheel 110 and a right rear wheel 112. The rear wheel braking system may include a second brake fluid circuit 124 coupled to a left rear wheel brake actuator 118 and a right rear wheel actuator 120, respectively. Each of the wheel brake actuators 114, 116, 118, and 120 may include a slave cylinder (not shown) and a friction member (not shown) for engaging a rotatable braking surface of the wheels 106, 108, 110, and 112, respectively.

When the brakes are engaged, a brake temperature increases. As brake temperature increases, a smoothness of the stopping or deceleration is impacted. The present disclosure is directed to systems and methods to accommodate temperature increases during stopping sequences while in the ACC mode. For example, if the driver has selected ACC mode and set a first speed, a plurality of sensors including a plurality of proximity sensors 132 that are positioned at a front end 104 of the vehicle 102 will collect data regarding an environment in which the vehicle is traveling. One or more of the plurality of proximity sensors 132 alone or in combination with a processing unit, such as an application specific integrated circuit that may be in a same package with the sensor, calculate a distance between the vehicle 102 and another vehicle or an object in a path of travel of the vehicle 102. For ease of discussion, through the specification, the object will refer to another vehicle or object in the path of travel detected by the sensors. Some of the sensors can detect a relative velocity of the object in relation to the vehicle 102. The relative velocity is as difference between velocities of the vehicle 102 and the object.

The one or more of the plurality of proximity sensors 132 may be for instance optical sensors, lasers, cameras, time of flight sensors, radar, sonar, ultrasonic sensors, fiber optic sensors, or hall-effect sensors. The plurality of sensors may include micro-electromechanical sensors, such as gyroscopes and accelerometers that provide acceleration, position, and velocity information. The proximity sensors 132, in one embodiment, may be one or more sensors of a same type that calculate proximity and use either the plurality of measurements or an average of the measurements to compare with a safe threshold distance. The proximity sensors 132, in another embodiment, are a combination of different sensors that calculate proximity and use the measurements to compare to the safe threshold distance.

The ACC system 128 of the system 100 is coupled to the braking system and to the processor 130. The ACC system receives the distance information and control signals from the plurality of sensors 132 from the processor in some embodiments. In other embodiments, the sensors may be directly coupled to the ACC system 128. The ACC 128 maneuvers or otherwise controls the vehicle 102 to achieve a driver selected speed until the ACC system 128, either alone or in combination with the processor and the sensors, detects the other vehicle or the object as it interferes with a trajectory of the vehicle 102 in the predicted path of travel. Said differently, upon detection of another vehicle or object within a distance of the vehicle by the sensors and the processor, the ACC will automatically adjust a speed of the vehicle 102. The distance being a safe distance during travel between the vehicle and the object or other vehicle in a roadway. To adjust the speed, the ACC system 128 activates the braking system.

The ACC system 128 uses the one or more of the plurality of proximity sensors 132 to maintain a predetermined threshold distance between the object in the path of travel of the vehicle 102. The ACC system 128 automatically slows down the vehicle 102 if the distance, as calculated by the one or more of the plurality of proximity sensors 132, is less than a predetermined safe threshold distance. The predetermined threshold distance is a minimum distance between the vehicle 102 and the object in the predicted path of travel of the vehicle 102 that should be maintained to ensure collision avoidance.

Alternately, the ACC system 128 automatically speeds up the vehicle 102 if the distance, as calculated by the one or more of the plurality of proximity sensors 132, is more than the predetermined threshold distance. The ACC system and the sensors continuously evaluate the environment around the vehicle, in particular, in front of the vehicle along a path of travel. While the ACC is activated, the sensors are continuously detecting distances and other information regarding the roadway ahead of or in front of the vehicle. Accordingly, the ACC is continuously evaluating whether to slow down the vehicle, maintain the vehicle, or increase the vehicle's speed. The ACC system 128 allows maintenance of safe vehicle separation on roadways. The ACC system 128 allows integration with other driver assistance features, such as in autonomous driving environments.

The ACC system 128 is communicatively coupled to the braking system 134, which is communicatively coupled to the plurality of proximity sensors 132, and the processor 130. The processer 130 is, thus, communicatively coupled to the proximity sensors 132, the ACC system 128, and the braking system 134. In an embodiment, the processor 130 is an Application Specific Integrated Circuit (ASIC) or other central processing unit that includes a memory (not shown in the Figure) for storing one or more threshold distances and other ACC information, including software for operating the braking system. The memory may be a completely embedded within the processor or may include remote access to a remote database, such as for map or location information. The remote database may be access through a variety of wireless communication techniques known in the art. The embedded memory may be read only memory, random access memory, a combination of these, or other suitable memory structures.

Further, the ACC system 128 is communicatively coupled to the proximity sensors 132, the braking system 134 and the processor 130. In-vehicular communication protocols, for example Controller Area Network (CAN), Local Interconnected Network (LIN), FlexRay, etc., support communication between the ACC system 128, the processor 130, the plurality of proximity sensors 132, the braking system 134, and other components of the vehicle 102.

In some embodiments, the processor 130 receives proximity detection signals from the plurality of proximity sensors 132 and derives a proximity value with respect to a detected object. The processor 130 may derive the proximity value based on the distance between the vehicle 102 and the object and the relative velocity. Once calculated or determined, the proximity value is compared with the predetermined threshold distance to determine whether a braking action is to be engaged.

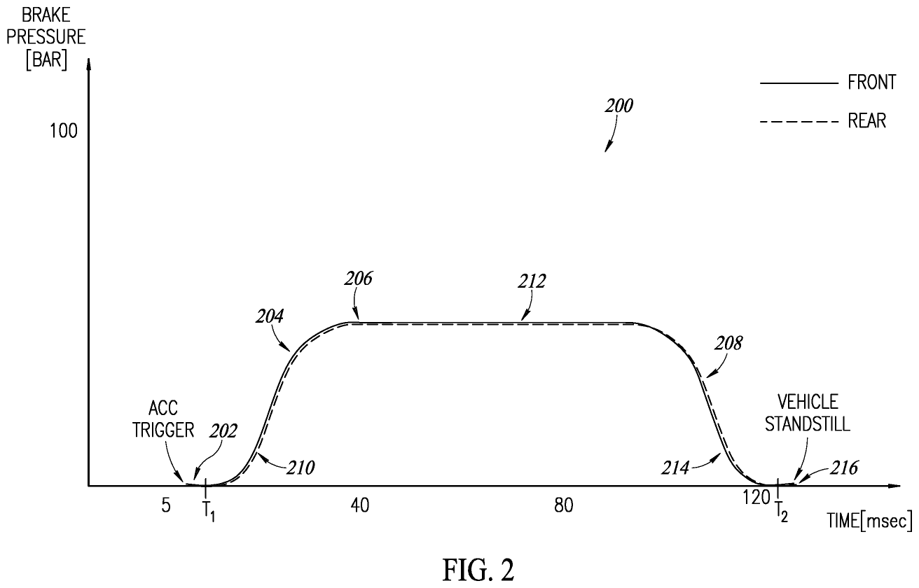

Upon detection of the object within the safe threshold distance, the ACC system will initiate a declaration sequence to automatically adjust to the change in the environment. Some braking systems control the front and rear brake systems at the same time, utilizing a braking pattern as illustrated in FIG. 2. Such a braking process can lead to harsh braking caused by heat build-up on the brakes as both the front and rear braking systems are activated at the same time with no cooling periods. As brake systems, especially rear braking systems exceed a threshold temperature, the brakes may start to vibrate or shake, impacting the experience of the passengers and driver.

While braking from greater than 20 kilometers per hour to zero, or stand still, a brake friction value has a wide dispersion. At a residual velocity between 0 and 5 kilometers per hour, the brake friction value can vary up to 50%. Such variation is a challenged for ACC deceleration and acceleration control, which evaluates and uses a pressure to torque value (Cp) to achieve a controlled stop.

In FIG. 2, the horizontal axis (x-axis) of the graph 200 is time (milliseconds) and the vertical axis (y-axis) is a brake pressure. The processor 130 generates an ACC braking signal on receipt of one or more proximity detection signals being below the predetermined threshold distance. The ACC system and/or the processor activates the braking system in response to the ACC braking signal, which corresponds to an ACC deceleration trigger 202 at time T1. The braking system may activate the front and rear brakes in a single control operation or may simultaneously control both the front and rear braking systems in a same pattern. In the Figure, the front braking system will be described as a first braking pattern and the rear braking system will be described as a second braking pattern. A braking period of the first braking pattern includes a first portion 204 that is an increasing brake pressure portion, a second portion 206 that is a stable brake pressure portion, and a third portion 208 that is a decreasing brake pressure portion. Similarly, the second braking pattern includes a first portion 210 that is an increasing brake pressure portion, a second portion 212 that is a stable brake pressure portion, and a third portion 214 that is a decreasing brake pressure portion.

The first braking pattern overlaps completely with the second braking pattern, which may include activating the front wheel brake actuators 114 and 116 parallelly with the rear wheel brake actuators 118 and 120. The vehicle 102 arrives at a standstill 216, T2 after completion of the third portions 208 and 214. The parallel application of the front wheel brake actuators 114 and 116 and the rear wheel brake actuators 118 and 120 leads to harsh stop of the vehicle 102 as neither system is provided any cooling time between application of brake pressure.

The front and the rear wheel brake actuators 114, 116 and 118, 120, respectively, generate heat in disc brakes as the brake actuators slow the vehicle 102. The brake system transforms kinetic energy into thermal energy. Physical contact of components of the brakes, like brake pads and rotors generate heat as the kinetic energy is converted to heat energy. Heat generation is proportional to speed of the vehicle 102, such that the attempt to stop the vehicle with higher speed generates higher amount of heat. Friction between the brake pads and the disc can lead to heat generation at boundary between the brake pads and the brake disc.

Surface temperatures of the disc and the brake pad vary with both time and position. Heat dissipation in quick stopping situations can be beneficial to minimize harsh stopping. Releasing the brake pressure, removes physical contact of the brake pads with the disc or rotor, which stops the heat generation and reduces the surface temperature of the brake pads and the disc.

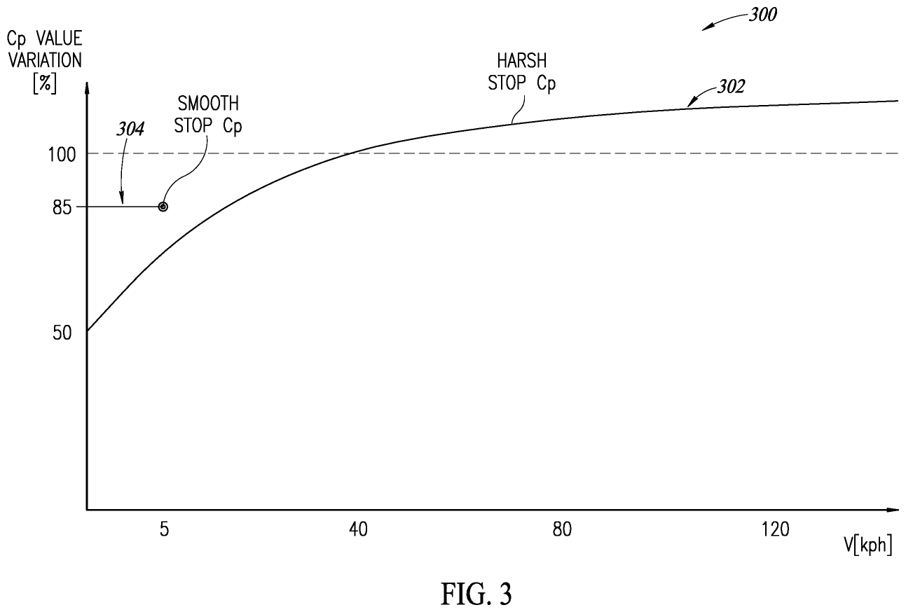

FIG. 3 is a graph of speed to pressure to torque (Cp) value variation as a percentage. At speeds greater than a first threshold, such as 40 kilometers per hour, the value variation exceed 100%, see curve 302. Such value variation in the pressure to torque can results in harsh stops. For lower speeds, lower than a second threshold, such as 5 kilometers per hour, the value variation may be closer to 85%, which corresponds to a smoother stopping experience. As such, it is desirable to mitigate the hard stopping that exists when the ACC system 128 decelerates from the selected speed when the object is detected. The present disclosure is directed to methods and systems to decelerate from speeds greater than the first threshold down to the second threshold is a smooth and controlled manner.

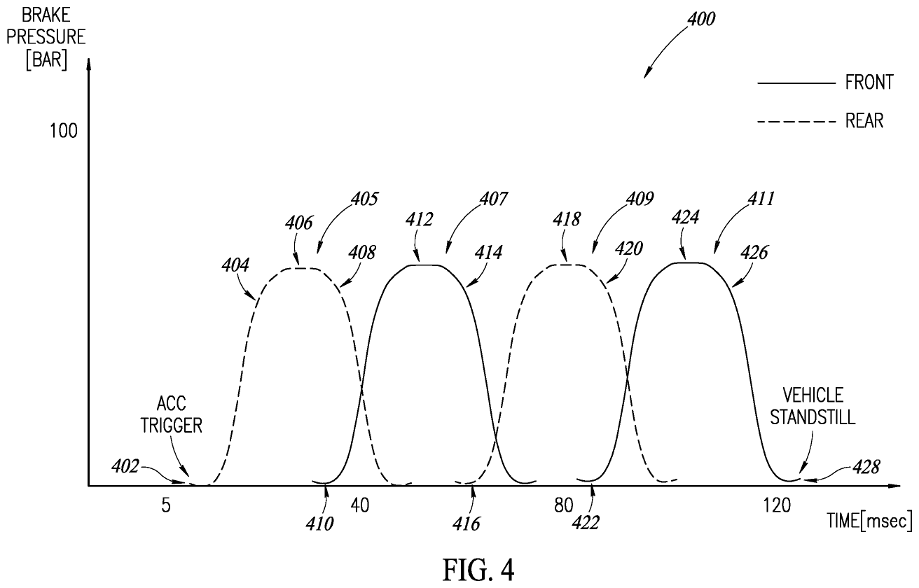

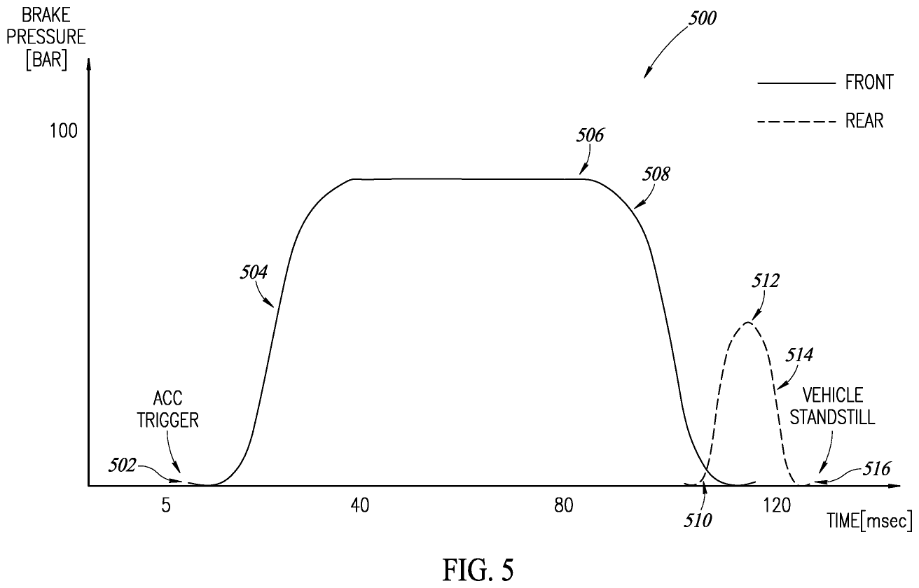

In order to minimize the risk of a harsh stop, the ACC system 128 will activate the front and rear braking systems in different patterns and at different time periods to allow for cooling periods for each braking system. Example patterns are described below with respect to FIGS. 4 and 5.

The processor 130 outputs a control signal in response to determining that the proximity value is above or below the predetermined threshold distance. The control signal may increase the braking pressure, decrease the braking pressure, or maintain the braking pressure. The processor 130 activates the braking system 134 in response to one or more of the proximity detection signals, when the distance detected by one or more of the plurality of proximity sensors or the derived proximity value is below the predetermined threshold distance.

The processor 130 activates the front wheel braking system 136 and the rear wheel braking system 138 in different patterns response to one or more deceleration signals. For example, ACC 128 may activate the front wheel braking system 136 for a first time period and the rear wheel braking system 138 for a second time period. The first time period may correspond to a first braking pattern and the second time period may correspond to a second braking pattern. For example, FIGS. 4 and 5 show different patterns that may be implemented. The front wheel braking system 136 and the rear wheel braking system 138 of the braking system 134 may supply pressurized brake fluid in response to the deceleration signal. The front wheel braking system 136 is controlled in the first braking pattern while the rear wheel braking system 138 is controlled in the second braking pattern. The braking system 134 may be alternately activated between the front brake actuators 114 and 116 and the rear brake actuators 118 and 120 with an overlap of the braking periods to achieve a smooth stop.

In some embodiments, the processor 130 is housed within the ACC system 128. The ACC system 128 receives the proximity detection signals from the one or more of the plurality of proximity sensors 132. The processor 130 processes the received proximity detection signals to derive the proximity value of the object or traffic lying ahead on the predicted path of travel. If the distance calculated by one or more of the plurality of proximity sensors being is below the predetermined threshold distance, then the ACC system 128 activates the braking system 134 to slow the vehicle 102, possibly to a complete stop. If the distance calculated by one or more of the plurality of proximity sensors exceeds the predetermined threshold distance, then the ACC system 128 accelerates the vehicle 102 up to either an originally selected cruise control speed or until the vehicle 102 is below or equal to the predetermined threshold distance again. The braking system 134 applies brakes in an alternating pattern to activate the front brake actuators 114 and 116 and to activate the rear brake actuators 118 and 120 with the overlap of the portion of braking periods of both the front brake actuators 114 and 116 and the rear brake actuators 118 and 120. In an embodiment, the alternating pattern initiates with the first braking pattern. In another embodiment, the alternating pattern initiates with the second alternating pattern. In an embodiment, the ACC system 128 includes a module comprising instructions to control the activation of the front wheel braking system 136 and the rear wheel braking system 138.

In another embodiment, the processor 130 is housed within the braking system 134 and operates in accordance with the embodiments of the present disclosure with the braking system 134 receiving the proximity detection signals from the one or more of the plurality of proximity sensors 132. The braking system 134 decelerates in response to the distance, as detected and or calculated by one or more of the plurality of proximity sensors, being below the predetermined threshold distance. If the distance of the plurality of proximity sensors is below the predetermined threshold distance, then the braking system 134 applies brakes in an alternating pattern to activate the front brake actuators 114 and 116 and to activate the rear brake actuators 118 and 120 with the overlap of the portion of braking periods of both the front brake actuators 114 and 116 and the rear brake actuators 118 and 120. In an embodiment, the alternating pattern initiates with the first braking pattern.

In another embodiment, the alternating pattern initiates with the second alternating pattern. In another embodiment, the processor 130 is shared between the ACC system 128 and the braking system 134. In an embodiment, the processor 130 is an Application Specific Integrated Circuit (ASIC) along with the memory for storing one or more threshold distance values.

In some embodiments, the braking system 134 activates the front brake actuators 114 and 116 and the rear brake actuators 118 and 120 in an alternating pattern with portion of overlap of the braking periods of both the front brake actuators 114 and 116 and the rear brake actuators 118 and 120. While one pattern is increasing another pattern is decreasing the brake pressure so that a cooling period is initiated. The braking systems are activated with these different patterns to allow cooling to mitigate the pressure to torque value variations.

The braking system 134 applies the alternating patterns until the vehicle decelerates to, for example, 5 kilometers per hour. As described with respect to FIG. 3, the pressure to torque value variations are less impactful on the stopping experience when less than 5 kilometers per hour (kph). As such, both braking systems can be engaged during the transition from 5 to 0 kilometers per hour. It is noted that the braking system 134 simultaneously activates the front brake actuators 114 and 116 and the rear brake actuators 118 and 120 until the vehicle 102 decelerates from, for example, 5 kph to a standstill, that is 0 kph. Alternatively, only the rear brakes may be engaged from 5 to 0 kilometers per hour.

The activation of the front brake actuators 114 and 116 and the rear brake actuators 118 and 120 alternately with the overlap provides time for the front brake actuators 114 and 116 and the rear brake actuators 118 and 120 to cool down during an inactivation period, i.e. no pressure is being applied. The front brake actuators 114 and 116 and the rear brake actuators 118 and 120 cool down to a temperature that is comparatively lower than the temperature of the front brake actuators 114 and 116 and the rear brake actuators 118 and 120 during the braking period, which may increase longevity. The overlap of the braking periods of the front brake actuators 114 and 116 and the rear brake actuators 118 and 120 allows smooth braking by avoiding jerks that are otherwise caused by activation of the of the front brake actuators 114 and 116 and the rear brake actuators 118 and 120, simultaneously for certain periods of time. When the ACC triggers a braking maneuver, the front and rear braking systems will be engaged or activated in an alternating manner. One will be inactive while the other is active, i.e. pressure is being applied to the brake components. During the inactive time periods that brake system will be allowed to cool. This results in a lower temperature while applying the brake pressure and maintains the pressure to torque (Cp) dispersion low. For example, as shown in FIG. 400, which illustrates a smooth braking process that applies periodic pressure to the front and rear braking systems. The horizontal axis (x-axis) is time, that is, milliseconds and vertical axis (y-axis) is brake pressure, that is, bar.

The processor 130 generates an adaptive cruise control braking (ACCB) signal upon identification of the objects in the predicted path of travel of the vehicle 102, as described above, i.e. an ACC Trigger. The ACCB signal activates the front wheel braking system 136, controlling the left front wheel brake actuator 114 and the right front wheel brake actuator 116 with the first braking pattern. The ACCB signal also activates the rear wheel braking system 138, controlling the left rear wheel brake actuator 118 and the right rear wheel brake actuator 120 with the second braking pattern.

In this embodiment, the second braking pattern is initiated before the first braking pattern, that is, activating the rear wheel braking system 138 occurs before activating the front wheel braking system 136. The first braking pattern is a similar pattern to the second braking pattern in duration and frequency of peaks of the pattern, however, the first pattern is staggered with respect to the second pattern.

A first peak 405 of the rear braking pattern, the second pattern corresponds to a maximum pressure applied during the first application of brake pressure. A first peak 407 of the front braking pattern, the first pattern corresponds to the maximum pressure applied to the second application of brake pressure. Each of the first and second patterns have a second peak, 411 and 409, respectively. Each of the peaks reach a same pressure value.

The braking system 134 activates the rear wheel brake actuators 118 and 120 at an instant of receiving the ACCB signal, that is, the Adaptive Cruise Control (ACC) trigger 402. The first braking pattern includes multiple braking periods and multiple inactive periods. Similarly, the second braking pattern includes multiple braking periods and multiple inactive periods, for example, two braking periods such as a first front and a second front braking period for the first braking pattern and two braking periods such as a first rear and a second rear braking period for the second braking pattern. The second braking pattern includes two braking periods that are the first rear braking period and the second rear braking period. The first braking pattern includes two braking periods that are the first front braking period and the second front braking period.

The first rear braking period of peak 405 of the second braking pattern includes a first increasing brake pressure portion 404, a second stable or maintained brake pressure portion 406, and a third decreasing brake pressure portion 408. The second rear braking period of the second braking pattern includes a first increasing brake pressure portion 416, a second stable or maintained brake pressure portion 418, and a third decreasing brake pressure portion 420.

Each period of increasing and decreasing brake pressure for one of the front or rear braking systems may be for a portion of the overall period of time for stopping. For example, each period may correspond to one quarter of the overall stop time. Alternatively, each period may be in the range of 30-50 milliseconds.

The first front braking period of the first braking pattern includes a first increasing brake pressure portion 410, a second stable or maintained brake pressure portion 412, and a third decreasing brake pressure portion 414. The second front braking period of the first braking pattern includes a first increasing brake pressure portion 422, a second stable or maintained brake pressure portion 424, and a decreasing brake pressure third portion 426.

As the pressure is released from the rear braking system during the decreasing brake pressure portion 408, pressure is applied to the front braking system with the increasing brake pressure portion 410. Similarly, the decreasing brake pressure portion 414 of first front braking period of the front braking system 136 overlaps with the increasing brake pressure portion 416 of the rear braking system 138. This overlapping decreasing and increasing of pressure is repeated with each period of application of brake pressure.

In another embodiment, the first braking pattern is initiated before the second braking pattern, that is, the rear wheel braking system 138 in the second braking pattern occurs after activating the front wheel braking system 136. The first braking pattern has a first plurality of braking periods and a first plurality of inactive periods and the second braking pattern has a second plurality of braking periods and a second plurality of inactive periods. In some embodiments, the vehicle 102 arrives at a standstill 428 after two braking periods of the rear wheel braking system 138 that is the second braking pattern and two braking periods of the front wheel braking system 136 that is the first braking pattern. The vehicle 102 may arrive at the standstill 428 at end of the third portion 426 of the first braking pattern.

The brake pressure at the second portions 406, 408 of the second braking pattern is equal to the brake pressure at the second portions 412, 424 of the first braking pattern. In an embodiment, the brake pressure at the second portions 406, 408 of the second braking pattern is greater than the brake pressure at the second portions 412, 424 of the first braking pattern. In another embodiment, the brake pressure at the second portions 406, 408 of the second braking pattern is lesser than the brake pressure at the second portions 412, 424 of the first braking pattern. The processor 130 performs a smooth braking process for decelerating the vehicle 102 from above 5 kph to equal to 5 kph. In an embodiment, the processor 130 continues the smooth braking process till the vehicle 102 decelerates to 0 kph. The alternating application of the front brakes and rear brakes allows the brakes to dissipate heat while during an inactive period. The inactive period of the front wheel braking system 136 is defined as the time period when braking operation by the front wheel braking system 136 is absent and the inactive period of the rear wheel braking system 138 is defined as the time period when braking operation by the rear wheel braking system 138 is absent. Therefore, this results in low temperature while applying the brake pressure and keeping Cp dispersion slightly low compared to Cp of the harsh braking as illustrated in the FIG. 3.

FIG. 5 is an alternative embodiment of a smooth braking process according to the present disclosure. In this embodiment, the ACC triggers a braking maneuver that alternatingly applies the front and rear brake pressure to achieve a smooth stop. This process includes initiating the front brake pressure only for the first and largest time period. The horizontal axis (x-axis) of graph 500 is time in milliseconds and vertical axis (y-axis) is brake pressure in bars.

The front brakes are engaged until the vehicle is decelerated under a threshold speed, such as 5 kilometers per hour. Once the threshold speed is crossed, the front brake pressure will be released and the rear brake pressure will be activated. This decrease and increase can occur simultaneously or in sequence. The rear brakes will be cool when engaged allowing for a smooth stop with low dispersed pressure to torque. The ACCD signal activates front wheel braking system 136 for controlling the left front wheel brake actuator 114 and the right front wheel brake actuator 116 based on the first braking pattern for a first time period (504, 508, 506). The first braking pattern is different from the second braking pattern (510, 512, 514, 516). The ACCD signal also activates the rear wheel braking system 138 for controlling the left rear wheel brake actuator 118 and the right rear wheel brake actuator 120 based on the second braking pattern for a second time period. In this embodiment, the first time period is greater than the second time period, for example, the first time period may be three times greater than the second time period.

The braking system 134 activates the front braking system upon receiving the ACCB signal, that is, an ACC trigger 502. The first braking pattern includes a first increasing brake pressure portion 504, a second stable brake pressure portion 506, and a third decreasing brake pressure portion 508. The second braking pattern includes a first increasing brake pressure portion 510, a second peak portion 512, and a third decreasing brake pressure portion 514. The processor 130 or ACC controller increases front brake pressure on the front wheel brake actuators 114 and 116 over the first portion 504 of the first time period. The second portion 506 of the first time period denotes a time period for which the processor 130 maintains the front brake pressure at a first pressure, to slow the vehicle. This may be for a period of 80 to 100 milliseconds in one embodiment. The front brake pressure on the front wheel brake actuators 114 and 116 is decreased by the processor 130 over the third portion 508 of the first time period. The processor 130 increases rear brake pressure on the rear wheel brake actuators 118 and 120 over the first portion 510 of the second time period. The decreasing of the front wheel brake pressure and the increasing of the rear wheel brake pressure may happen at the same time or overlapping. The second portion 512 of the second time period maintains the rear brake pressure at a second pressure that is less than the first pressure. The rear brake pressure on the rear wheel brake actuators 118 and 120 is decreased by the processor 130 over the third portion 514 of the second time period, which may end in a stop or standstill. In an alternative embodiment, the first brake pressure may be less than or equal to the second brake pressure. The vehicle 102 arrives at a standstill 516 at end of the third portion 514 of the second braking pattern. The front wheel braking system is utilized to reduce the speed of the vehicle from the highway speed selected by the driver down to 5 kilometers per hour. The rear wheel braking system is then engaged for the remaining deceleration, from 5 kilometers per hour down to zero.

The alternate braking application between the front wheels 106 and 108 and rear wheels 110 and 112 of the vehicle 102, in accordance with the present disclosure, enables the smooth stopping of the vehicle 102 as opposed to the harsh or “jerky” stopping. With alternate braking, generated thermal energy is not simultaneously concentrated on the disc brakes of the front wheels 106 and 108 of the vehicle 102 and the disc brakes of the rear wheels 110 and 112 of the vehicle 102. Therefore, there is enough time for the disc brakes of the front wheel 106 and 108 of the vehicle 102 to cool down while the rear wheel braking system 138 is applied. In a subsequent time cycle, when the front wheel braking system 136 is applied, the disc brakes of the rear wheels 110 and 112 gets enough time to cool down. Such distributed heat dissipation reduces probability of wear and tear of brake components of the vehicle 102. The various embodiments described above can be combined to provide further embodiments.

One embodiment of the present disclosure is directed to a system that includes a vehicle having a front end with a plurality of proximity sensors at the front end of the vehicle. The system includes an adaptive cruise control system and a braking system coupled to the adaptive cruise control system. The braking system includes a front wheel braking system and a rear wheel braking system. A processer is coupled to the plurality of proximity sensors, the adaptive cruise control system, and the braking system, the processor configured, in operation, to receive proximity detection signals from one or more of the plurality of proximity sensors, activate the braking system in response to one of the proximity detection signals being less than a safe threshold distance, activate the front wheel braking system for a first time period, and activate the rear wheel braking system for a second time period. The first time period is greater than the second time period. The first time period is at least three times greater than the second time period.

The processor generates a first deceleration signal in response to the proximity detection signals being less than the safe threshold distance and in response to the first deceleration signal the processor activates the front wheel braking system. The processor increases a front brake pressure over a first portion of the first time period. The processor maintains the front brake pressure at a first pressure over a second portion of the first time period. The processor decreases the front brake pressure over a third portion of the first time period. The processor increases a rear brake pressure over a first portion of the second time period. The third portion of the first time period overlaps with the first portion of the second time period.

A vehicle that includes a plurality of proximity sensors, an adaptive cruise control system, a front wheel braking system, and a rear wheel braking system. The vehicle a processer coupled to the plurality of proximity sensors, the adaptive cruise control system, and the front and rear braking systems, the processor is configured, in operation, to receive proximity detection signals from one or more of the plurality of proximity sensors, generate an adaptive cruise control braking signal in response to one or more of the proximity detection signals being less than a safe distance threshold, activate the front wheel braking system in a first braking pattern and the rear wheel braking system in a second braking pattern in response to the adaptive cruise control braking signal, the first braking pattern being different from the second braking pattern.

The first braking pattern is initiated before the second braking pattern. The first braking pattern has a first plurality of braking periods and a first plurality of inactive periods and the second braking pattern has a second plurality of braking periods and a second plurality of inactive periods. Each of the first plurality of braking periods includes an increasing brake pressure portion, a stable brake pressure portion, and a decreasing brake pressure portion and each of the second plurality of braking periods includes an increasing brake pressure portion, a stable brake pressure portion, and a decreasing brake pressure portion. The decreasing brake pressure portion of a first one of the first plurality of braking periods of the front wheel braking system overlaps with the increasing brake pressure portion of a first one of the second plurality of braking periods of the rear wheel braking system. The decreasing brake pressure portion of the first one of the second plurality of braking periods of the rear wheel braking system overlaps with the increasing brake pressure portion of a second one of the first plurality of braking periods of the front wheel braking system. The second braking pattern is initiated before the first braking pattern.

The second braking pattern has a first plurality of braking periods and a first plurality of inactive periods and the first braking pattern has a second plurality of braking periods and a second plurality of inactive periods. The first plurality of braking periods includes an increasing brake pressure portion, a stable brake pressure portion, and a decreasing brake pressure portion and each of the second plurality of braking periods includes an increasing brake pressure portion, a stable brake pressure portion, and a decreasing brake pressure portion. The decreasing brake pressure portion of a first one of the first plurality of braking periods of the rear wheel braking system overlaps with the increasing brake pressure portion of a first one of the second plurality of braking periods of the front wheel braking system.

Another embodiment is directed to a method that includes controlling a front brake system and a rear braking system of a vehicle in response to adaptive cruise control deceleration signals, the controlling including: activating the front brake system in a first braking pattern and activating the rear brake system in a second braking pattern that is different from the first braking pattern. The first braking pattern corresponds to a first time period and the second braking pattern corresponds to a second time period. The first time period is greater than the second time period. The first time period is at least three times greater than the second time period. The activating the front brake system in the first braking pattern includes increasing a front brake pressure over a first portion of first time period, maintaining the front brake pressure at a first pressure over a second portion of the first time period, and decreasing the front brake pressure over a third portion of the first time period. The activating the rear brake system in the second braking pattern includes increasing a rear brake pressure over a first portion of the second time period, the third portion of the first time period overlaps with the first portion of the second time period.

The first braking pattern includes a first increasing brake pressure time period, a first maintained brake pressure time period, and a first decreasing brake pressure time period and the second braking pattern includes a second increasing brake pressure time period, a second maintained brake pressure time period, and a second decreasing brake pressure time period. The activating the rear brake system in the second braking pattern occurs after activating the front brake system. The activating of the front brake system includes activating the first braking pattern in a first plurality of braking periods and a first plurality of inactive periods and activating of the rear brake system includes activating the second braking pattern in a second plurality of braking periods and a second plurality of inactive periods. Each of the first plurality of braking periods includes an increasing brake pressure portion, a stable brake pressure portion, and a decreasing brake pressure portion and each of the second plurality of braking periods includes an increasing brake pressure portion, a stable brake pressure portion, and a decreasing brake pressure portion. The decreasing brake pressure portion of a first one of the first plurality of braking periods of the front wheel braking system overlaps with the increasing brake pressure portion of a first one of the second plurality of braking periods of the rear wheel braking system. The decreasing brake pressure portion of the first one of the second plurality of braking periods of the rear wheel braking system overlaps with the increasing brake pressure portion of a second one of the first plurality of braking periods of the front wheel braking system.

The plurality of the decreasing portions of the second braking pattern may overlap with the plurality of the increasing portion of the first braking pattern to maintain a smooth stop experience for the driver or passengers. By alternating which braking system, rear or front is experiencing the increasing brake pressure portion, the heat build-up and subsequent physical, vibrational consequences are minimized or avoided. The plurality of the decreasing portions of the first braking pattern can overlap with the plurality of the increasing portions of the second braking pattern. The maintained brake pressure portion is also referred as the stable brake pressure portion.

In an alternate embodiment, the second braking pattern is initiated after the first braking pattern. The plurality of the decreasing portions of the first braking pattern overlap with the plurality of the increasing portions of the second braking pattern. The plurality of the decreasing portions of the second braking pattern overlap with the plurality of the increasing portions of the first braking pattern.

In an alternative embodiment, the vehicle can collect data from a variety of locations and automatically adjust the cruise control speed to match a requirement of the particular roadway on which the vehicle is traveling. For example, the ACC can use global positioning system information to determine a location of the vehicle 102 and can obtain corresponding allowable speed limit data from stored map data or remotely accessible map data where the data is stored in a database. The ACC system 128 dynamically sets the speed limit for the vehicle 102 based on the allowable speed limit data of the determined location obtained from the database.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments considering the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a vehicle having a front end, the vehicle including:
a plurality of proximity sensors at the front end of the vehicle;
a braking system coupled to the plurality of proximity sensors, the braking system including:
a front wheel braking system; and
a rear wheel braking system;
a processer coupled to the plurality of proximity sensors and the braking system, the processor configured, in operation, to:
receive proximity detection signals from one or more of the plurality of proximity sensors;
activate the braking system in response to one of the proximity detection signals being less than a safe threshold distance;
activate the front wheel braking system for a first time period; and
activate the rear wheel braking system for a second time period.

2. The system of claim 1 wherein the first time period is greater than the second time period.

3. The system of claim 1 wherein the processor generates a first deceleration signal in response to the proximity detection signals being less than the safe threshold distance; and
in response to the first deceleration signal the processor activates the front wheel braking system.

4. The system of claim 3 wherein the processor increases a front brake pressure over a first portion of the first time period, the processor maintains the front brake pressure at a first pressure over a second portion of the first time period, and the processor decreases the front brake pressure over a third portion of the first time period.

5. The system of claim 4 wherein the processor increases a rear brake pressure over a first portion of the second time period.

6. The system of claim 5 wherein the third portion of the first time period overlaps with the first portion of the second time period.

7. A vehicle, comprising:
a plurality of proximity sensors;
an adaptive cruise control system;
a front wheel braking system; and
a rear wheel braking system;
a processer coupled to the plurality of proximity sensors, the adaptive cruise control system, and the front and rear braking systems, the processor is configured, in operation, to:
receive proximity detection signals from one or more of the plurality of proximity sensors;
generate an adaptive cruise control braking signal in response to one or more of the proximity detection signals being less than a safe distance threshold;
activate the front wheel braking system in a first braking pattern and the rear wheel braking system in a second braking pattern in response to the adaptive cruise control braking signal, the first braking pattern being different from the second braking pattern.

8. The vehicle of claim 7 wherein the first braking pattern is initiated before the second braking pattern.

9. The vehicle of claim 8 wherein the first braking pattern has a first plurality of braking periods and a first plurality of inactive periods and the second braking pattern has a second plurality of braking periods and a second plurality of inactive periods.

10. The vehicle of claim 9 wherein the decreasing brake pressure portion of a first one of the first plurality of braking periods of the front wheel braking system overlaps with the increasing brake pressure portion of a first one of the second plurality of braking periods of the rear wheel braking system.

11. The vehicle of claim 10 wherein the decreasing brake pressure portion of the first one of the second plurality of braking periods of the rear wheel braking system overlaps with the increasing brake pressure portion of a second one of the first plurality of braking periods of the front wheel braking system.

12. The vehicle of claim 7 wherein the second braking pattern is initiated before the first braking pattern, the second braking pattern has a first plurality of braking periods and a first plurality of inactive periods and the first braking pattern has a second plurality of braking periods and a second plurality of inactive periods.

13. The vehicle of claim 12 wherein each of the first plurality of braking periods includes an increasing brake pressure portion, a stable brake pressure portion, and a decreasing brake pressure portion and each of the second plurality of braking periods includes an increasing brake pressure portion, a stable brake pressure portion, and a decreasing brake pressure portion, the decreasing brake pressure portion of a first one of the first plurality of braking periods of the rear wheel braking system overlaps with the increasing brake pressure portion of a first one of the second plurality of braking periods of the front wheel braking system.

14. A method, comprising:
detecting a plurality of environmental conditions around a vehicle;
generating an automatic deceleration control signal based on the plurality of environmental conditions;
controlling a front brake system and a rear braking system of a vehicle in response to the automatic deceleration control signal, the controlling including:
activating the front brake system in a first braking pattern;
activating the rear brake system in a second braking pattern that is different from the first braking pattern.

15. The method of claim 14 wherein the first braking pattern corresponds to a first time period and the second braking pattern corresponds to a second time period.

16. The method of claim 15 wherein the first time period is greater than the second time period.

17. The method of claim 14 wherein the activating the front brake system in the first braking pattern includes increasing a front brake pressure over a first portion of first time period, maintaining the front brake pressure at a first pressure over a second portion of the first time period, and decreasing the front brake pressure over a third portion of the first time period, the activating the rear brake system in the second braking pattern includes increasing a rear brake pressure over a first portion of the second time period, the third portion of the first time period overlaps with the first portion of the second time period.

18. The method of claim 14 wherein the first braking pattern includes a first increasing brake pressure time period, a first maintained brake pressure time period, and a first decreasing brake pressure time period and the second braking pattern includes a second increasing brake pressure time period, a second maintained brake pressure time period, and a second decreasing brake pressure time period.

19. The method of claim 18 wherein the activating the rear brake system in the second braking pattern occurs after activating the front brake system, the activating of the front brake system includes activating the first braking pattern in a first plurality of braking periods and a first plurality of inactive periods and activating of the rear brake system includes activating the second braking pattern in a second plurality of braking periods and a second plurality of inactive periods.

20. The method of claim 19 wherein each of the first plurality of braking periods includes an increasing brake pressure portion, a stable brake pressure portion, and a decreasing brake pressure portion and each of the second plurality of braking periods includes an increasing brake pressure portion, a stable brake pressure portion, and a decreasing brake pressure portion, the decreasing brake pressure portion of a first one of the first plurality of braking periods of the front wheel braking system overlaps with the increasing brake pressure portion of a first one of the second plurality of braking periods of the rear wheel braking system.
